(19) United States
(12) Patent Application Publication
(10) Pub. No.: US 2014/0123177 A1
(43) Pub. Date: May 1, 2014

(54) PRE-ENCODED USER INTERFACE VIDEO

(71) Applicant: KT Corporation, Seongnam-si (KR)

(72) Inventors: I Gil KIM, Suwon-si (KR); Dong Hoon KIM, Yongin-si (KR); Gyu Tae BAEK, Seoul (KR)

(73) Assignee: KT Corporation, Seongnam-si (KR)

(21) Appl. No.: 14/069,505

(22) Filed: Nov. 1, 2013

(30) Foreign Application Priority Data
Nov. 1, 2012 (KR) 10-2012-0123169

(51) Int. Cl. H04N 21/472

(52) U.S. Cl. CPC H04N 21/47202; H04N 21/47217
USPC 725/34; 725/61

(57) ABSTRACT

In at least one example embodiment, in connection with a device having a user interface (UI), a method may include transmitting a request for VOD (video on demand) content to a content provider; receiving, from the content provider, a UI stream and the requested VOD content, the UI stream including a VOD header and a plurality of UI videos corresponding to the VOD content; playing a first UI video from among the plurality of UI videos; receiving a first user input; selecting a second UI video from among the plurality of UI videos based at least in part on the first user input; and playing the second UI video.

### TECHNICAL FIELD

The embodiments described herein pertain generally to a user interface.

### BACKGROUND

A user can watch video on demand (VOD) content by downloading or streaming the VOD content from a content provider whenever the user wants. Further, the user may control various aspects of VOD content play on a display device including, but not limited to, rewind, fast forward, pause, or stop.

### SUMMARY

In one example embodiment, in connection with a device having a user interface (UI), a method may include transmitting a request for VOD (video on demand) content to a content provider; receiving, from the content provider, a UI stream and the requested VOD content, the UI stream including a VOD header and a plurality of UI videos corresponding to the VOD content; playing a first UI video from among the plurality of UI videos; receiving a first user input; selecting a second UI video from among the plurality of UI videos based at least in part on the first user input; and playing the second UI video.

In another example embodiment, a device may include a transmitter configured to transmit a request for VOD (video on demand) content to a content provider; a receiver configured to receive, from the content provider, a UI stream and the requested VOD content, the UI stream including a VOD header and a plurality of UI videos corresponding to the VOD content; a user input receiver configured to receive a user input; a controller configured to select a UI video from among the plurality of UI videos based at least in part on the user input; and a reproducing unit configured to play the selected UI video in response to an instruction of the controller.

In yet another example embodiment, a system may include a content provider configured to: receive a request for VOD (video on demand) content; and transmit a UI stream and the requested VOD content, the UI stream including a VOD header and a plurality of UI videos corresponding to the VOD content, and a device configured to: receive the UI stream and the VOD content from the content provider; play a first UI video from among the plurality of UI videos; receive a user input; select a second UI video from among the plurality of UI videos based at least in part on the user input; and play the second UI video.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of playing user interface (UI) video may be implemented, in accordance with various embodiments described herein;

FIG. 2 shows an illustrative example of a UI stream, in accordance with various embodiments described herein;

FIG. 3 shows an example configuration of a device by which at least portions of playing of a UI video may be implemented, in accordance with various embodiments described herein;

FIG. 4A shows an illustrative example of changing of UI video based at least in part on a user input, in accordance with various embodiments described herein;

FIG. 4B shows an illustrative example of a matching information table which may be included in a VOD header, in accordance with various embodiments described herein;

FIG. 5 shows an illustrative example of a three-dimensional (3D) UI video played by a device by which at least portions of playing of a UI video may be implemented, in accordance with various embodiments described herein;

FIG. 6 shows an example processing flow of operations to implement at least portions of playing of a UI video may be implemented, in accordance with various embodiments described herein; and

FIG. 7 shows an illustrative computing embodiment, in which any of the processes and sub-processes of a playing of a UI video may be implemented as computer-readable instructions stored on a computer-readable medium, in accordance with various embodiments described herein.

All of the above may be arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

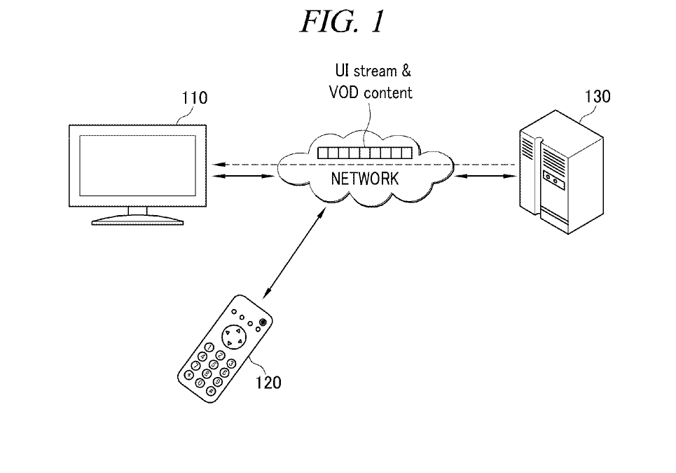

FIG. 1 shows an example system configuration in which one or more embodiments of playing UI video may be implemented, in accordance with various embodiments described herein. As depicted in FIG. 1, a system configuration 100 may include, at least, a device 110 that is playing VOD (video on demand) content, a remote controller 120 and a content provider 130 that is representative of a server operated by a content provider. At least two or more of device 110, remote controller 120, and content provider 130 may be communicatively connected to each other via a network 130.

Device 110 may refer to at least one of an IPTV (internet protocol television), a DTV (digital television), a smart TV, a connected TV or a STB (set-top box).

Device 110 may be configured to transmit, to content provider 130, a request for the VOD content to play the VOD content. By way of example, but not limitation, device 110 may receive a user input that selects the VOD content from among lots of VOD content, and transmit the request for the selected VOD content to content provider 130. As referenced herein, a user of device 110 may select the VOD content from among lots of VOD content by manipulating remote controller 120. Then, device 110 may be configured to receive the selected VOD content and to play the received VOD.

Generally, device 110 may be configured to display a menu UI including some icons corresponding to the VOD content, prior to playing of the VOD content. In this case, when the user selects an icon corresponding to request for playing of the VOD content from among some of the icons, device 110 may play the VOD content. Alternatively, when the user selects another icon from among some of the icons, device 110 may display corresponding UI, such as an image or a video.

As referenced herein, if device 110 has a low performance, device 110 may not display a high performance UI such as a high-definition motion UI, 3D motion UI, splendid UI, etc. Thus, device 110 may receive lots of UI videos pre-encoded, pre-dubbed or pre-recorded by content provider 130 to display high performance UIs.

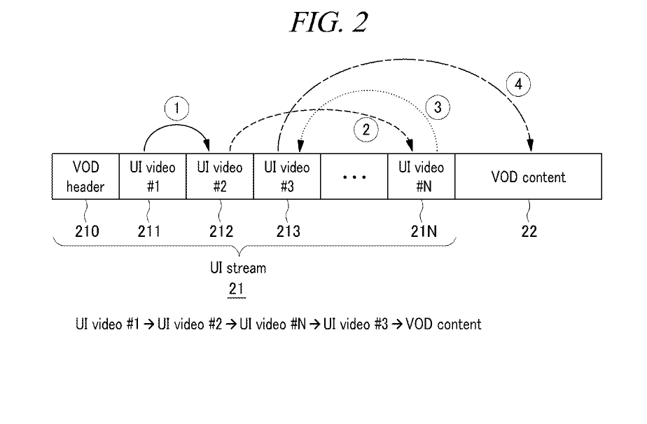

As referenced herein, a UI stream may include a VOD header and lots of UI videos and each of the UI videos may be changed from one UI video to another UI video based at least in part on a user input as depicted and described with reference to FIG. 2.

FIG. 2 shows an illustrative example of a UI stream 21, in accordance with various embodiments described herein. As depicted in FIG. 2, the UI stream 21 may include VOD header 210 and UI videos 211 to 21N.

VOD header 210 may include information (or data) regarding VOD content 22 and UI videos 211 to 21N. By way of example, but not limitation, VOD header 210 may include codec information, resolution information or format information of VOD content 22. Further, VOD header 210 may include information regarding each address of respective UI videos 211 to 21N and matching information that matches each of UI videos 211 to 21N with each user input.

Each of UI videos 211 to 21N are pre-encoded videos by content provider 130 to allow device 110 to play UI videos 211 to 21N irrespective of a performance of device 110. By way of example, but not limitation, in spite of low-performance for device 110, device 110 may display 3D motion UI by just playing the pre-encoded UI videos.

On receiving VOD header 210, UI videos 211 to 21N and VOD content 22 from content provider 130, device 110 may play a first UI video 211. During playing of first UI video 211, if device 110 receives a first user input, device 110 may stop the playing of first UI video 211 and start to play a second UI video 212. Similarly, during playing of second UI video 212, if device 110 receives a second user input, device 110 may stop the playing of second UI video 212 and start to play a Nth UI video 21N. Further, device 110 may stop the playing of Nth UI video 21N and start to play a third UI video 213 in response to a third user input. At this time, device 110 may play VOD content 22 upon receiving a fourth user input while third UI video 213 is played on device 110.

Although VOD header 210 is illustrated in FIG. 2 as a part of UI stream 21, VOD header 210 may not be included in UI stream 21. Alternatively, only a part corresponding to UI videos 211 to 21N of VOD header 210 may be included in UI stream 21 as a UI video header.

Thus, FIG. 2 shows an illustrative example of UI stream 21, in accordance with various embodiments described herein.

Referring again to FIG. 1, as set forth above, device 110 may be configured to receive, from content provider 130, the UI stream including the VOD header and lots of the UI videos, and the VOD content. Specifically, device 110 may receive the UI stream and the VOD content in a streaming manner from content provider 130. In this case, receiving of lots of the UI videos may be performed prior to the receiving of the VOD content, thus device 110 may play one of the UI videos even before the VOD content reaches device 110.

Further, device 110 may play a first UI video from among lots of the received UI videos. As referenced herein, the first UI video may be played by device 110 when receiving a user input that requests for the first UI video. Alternatively, the first UI video may be played by device 110 upon device 110 receiving the UI stream without any user inputs.

When device 110 receives a particular user input, device 110 may be configured to select a second UI video from among lots of the UI videos based at least in part on the received particular user input, and play the selected second UI video.

Remote controller 120 may be configured to control the playing of the VOD content. That is, by manipulating remote controller 120, remote controller 120 may control the playing of the video content, such as calling a menu UI, pause/playback, rewind, fast forward, or stop for the VOD content. During the controlling of the playing of the VOD content, UI videos may be played by device 110, and played UI video may be changed into another UI video based at least in part on the controlling of the playing of the VOD content.

When remote controller 120 may receive a user input that clicks, selects, or otherwise activates at least one button or icon on remote controller 120 to control the playing of the video content, remote controller 120 may generate and transmit a control signal to device 110. If remote controller 120 is directly paired or connected with device 110, the control signal is directly transmitted from remote controller 120 to television device 110. Alternatively, if remote controller 120 is not directly paired or connected with device 110, the control signal is transmitted, via content provider 130, from remote controller 120 to device 110.

As referenced herein, remote controller 120 may be a mobile device, and an application controlling the playing of the VOD content is hosted and executed on the mobile device. If the user wants to control the playing of the VOD content, the user may download the application from virtual application market, such as the Apple™ App Store, the Google™ Google Play, etc.

The mobile device may refer to at least one of a mobile phone, a smart phone, a portable device, a notebook, a personal computer or a personal communication terminal. Non-limiting examples of such mobile devices may include PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

Content provider 130 that represents a server operated by the content provider may be configured to receive the request for the VOD content from device 110 (or remote controller 120). Further, in response to the request for the VOD content, content provider 130 may transmit, to device 110, the requested VOD content with the UI stream including the VOD header and lots of the UI videos corresponding to the VOD content.

As referenced herein, content provider 130 may prepare lots of the UI videos by encoding each of the UI videos. Specifically, content provider 130 may encode every possible UI video based at least in part on every user input.

Non-limiting examples of content provider 130 may include an Internet service provider (ISP); application service provider (ASP); storage service provider (SSP); and television service provider, i.e., cable TV, DSL and DBS.

By way of example, but not limitation, network 130, which may be configured to communicatively couple one or more of device 110, remote controller 120, and content provider 130, may, be implemented in accordance with any wireless network protocol, such as a mobile radio communication network including at least one of a 3rd generation (3G) mobile telecommunications network, a 4th generation (4G) mobile telecommunications network, any other mobile telecommunications networks, a satellite network, the Internet, WiBro (Wireless Broadband Internet), Mobile WiMAX, HSDPA (High Speed Downlink Packet Access) or the like.

Thus, FIG. 1 shows an example system configuration in which one or more embodiments of playing UI video may be implemented, in accordance with various embodiments described herein.

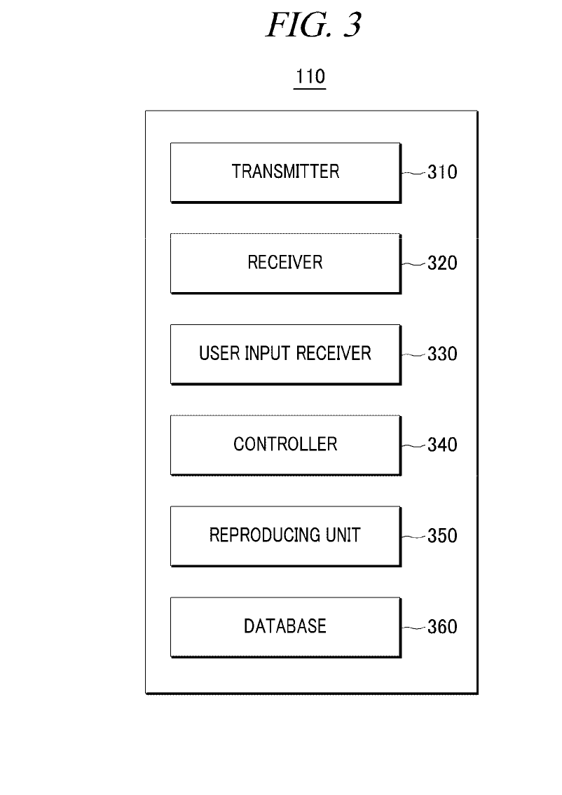

FIG. 3 shows an example configuration of device 110 by which at least portions of control of playing of a UI video may be implemented, in accordance with various embodiments described herein. As depicted in FIG. 3, device 110, which is described above with regard to FIG. 1, may include a transmitter 310, a receiver 320, a user input receiver 330, a controller 340, a reproducing unit 350, and a database 360.

Although illustrated as discrete components, various components may be divided into additional components, combined into fewer components, or eliminated altogether while being contemplated within the scope of the disclosed subject matter. Each function and/or operation of the components may be implemented, individually and/or collectively, by a wide range of hardware, software, firmware, or any combination thereof. In that regard, one or more of transmitter 310, receiver 320, user input receiver 330, controller 340, reproducing unit 350, and database 360 may be included in an instance of an application hosted by device 110.

Transmitter 310 may be configured to transmit, content provider 130, a request for VOD content from among a plurality of VOD content that possessed by content provider 130.

Receiver 320 may be configured to receive, from content provider 130, a UI stream and the requested VOD content. As referenced herein, the UI stream may include a VOD header and a plurality of UI videos corresponding to the VOD content. Further, the VOD header may include information regarding each address of the plurality of UI videos and matching information that matches each of the plurality of UI videos with each user input.

Each of the plurality of UI videos may be pre-encoded by content provider 130 to allow device 110 to play the plurality of UI videos irrespective of a performance of device 110. In some embodiment, the receiving of the plurality of UI videos may be performed prior to the receiving of the VOD content in a streaming method. In this case, the VOD header may include scheduling information on transmitting of the UI stream and the VOD content.

In some embodiment, receiver 320 may be configured to receive only the UI stream in advance, and receiver 320 may further receive the VOD content upon receiving a request to reproduce the VOD content.

Receiver 320 may receive, from content provider 130, a UI data corresponding to the VOD content to display the UI data as a background.

User input receiver 330 may be configured to receive a user input from a user of device 110 via remote controller 120. Further, user input receiver 330 may be receive a request to reproduce the VOD content from the user.

Controller 340 may be configured to select a UI video from among the plurality of UI videos based at least in part on the user input.

Reproducing unit 350 may be configured to reproduce the selected UI video in response to an instruction of the controller. In some embodiment, if receiver 320 receives the UI data from content provider 130, reproducing unit 350 may reproduce the selected UI video on a predetermined area on the displayed UI data.

Reproducing unit 350 may be configured to reproduce the selected UI video repeatedly if a next user input is not received although the playing of the selected UI video is completed.

Further, when user input receiver 330 receiving a next user input, controller 340 may select a next UI video from among the plurality of UI videos based at least in part on the next user input, and reproducing unit 350 may reproduce the selected next UI video. In this case, reproducing unit 350 may reproduce the selected next UI video with stopping the reproduction of the reproduced UI video. Alternatively, reproducing unit 350 may reproduce the selected next UI video while reproducing the selected UI video. That is, both of the UI video and the next UI video may be simultaneously reproduced.

Database 360 may be configured to store data, including data input to or output from the components of device 110. Non-limiting examples of such data may include the information included in the VOD header which is received by receiver 320.

Further, by way of example, database 360 may be embodied by at least one of a hard disc drive, a ROM (Read Only Memory), a RAM (Random Access Memory), a flash memory, or a memory card as an internal memory or a detachable memory of remote controller 110.

Thus, FIG. 3 shows an example configuration of a device by which at least portions of control of playing of a UI video may be implemented, in accordance with various embodiments described herein.

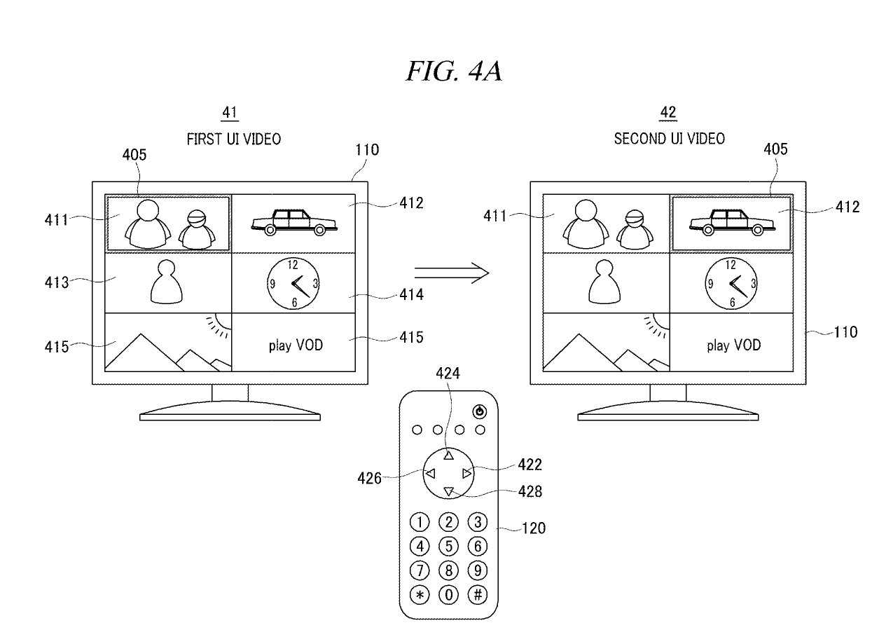

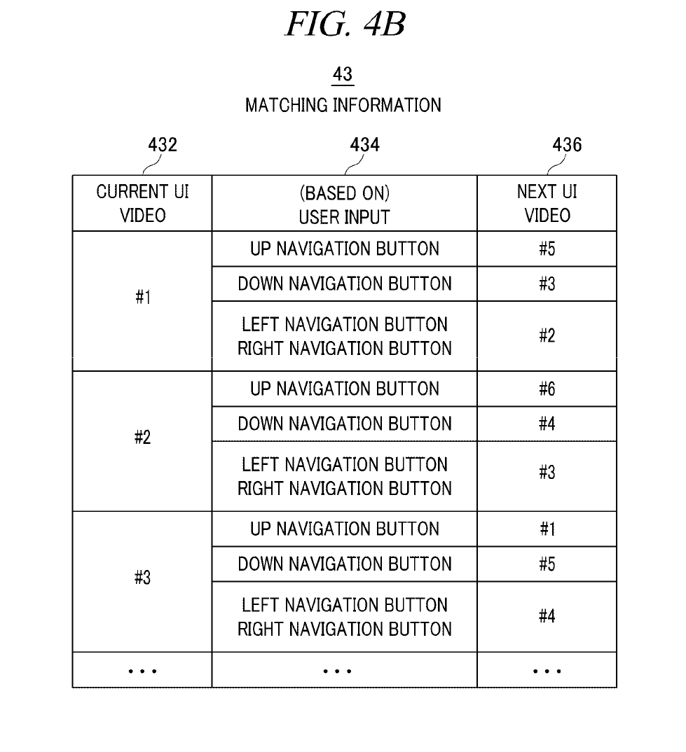

FIG. 4A shows an illustrative example of changing of UI video from a first UI video 41 to a second UI video 42 based at least in part on a user input, in accordance with various embodiments described herein. As depicted in FIG. 4A, device 110 may play first UI video 41 when receiving a UI stream including a VOD header and lots of UI videos.

If remote controller 120 may receive a user input that clicks, selects, or otherwise activates a right navigation button or icon 422 on remote controller 120 while device 110 playing first UI video 410, device 110 may stop playing of first UI video 41 and start to play second UI video 42. By way of example, but not limitation, at first, device 110 may play first UI video 41 showing that a first area 411 within a select box 405 changes in time while the other areas are not changed in time. Then, when remote controller 120 receives the user input that pushes right navigation button 422, device 110 may play second UI video 42. As referenced herein, playing second UI video 42 may show that select box 405 moves from first box 410 including two men to a second area 412 including a car; and second area 412 within select box 405 changes in time while the other areas are not changed in time. That is, first UI video 41 may represent a video showing changes to first area 411 including the two men, and second UI video 42 may represent a video showing changes second area 412 including the car.

In some embodiment, both playing first UI video 41 and playing second UI video 42 may also show that all areas are changing in time, but a difference between playing first UI video 41 and playing second UI video 42 may be a respective position of select box 405.

Two cases referred above may represent that first UI video 41 and/or second UI video 42 is played full-screen size. However, in some other embodiment, first UI video 41 and/or second UI video 42 may be occupy only a part of the full-screen size. In this case, to prevent remained unoccupied part of the full-screen size from being displayed with black-screen, device 110 may receive a UI data from content provider 130. By way of example, but not limitation, device 110 may receive and execute the UI data to display a UI corresponding to the UI data as a background, and device 110 may play first UI video 41 and/or second UI video 42 on a predetermined area on the displayed UI data.

Thus, FIG. 4A shows an illustrative example of changing of UI video from first UI video 41 to second UI video 42 based at least in part on a user input, in accordance with various embodiments described herein.

FIG. 4B shows an illustrative example of a matching information table 43 which may be included in a VOD header, in accordance with various embodiments described herein. As depicted in FIG. 4B, there is an illustrative example of matching information table 43 pertaining to a UI change based at least in part on a user input.

Matching information table 43 may include a current UI video column 432, a user input column 434, and a next UI video column 436. By way of example, but not limitation, as shown in matching information table 43, when remote controller receives a user input that pushes a up navigation button 424 while device 110 playing first UI video 41, device 110 may play a fifth UI video showing that a fifth area 415 including a mountain changes in time. Similarly, when remote controller 120 receives a user input that pushes right navigation button 422 or a left navigation button 426 while device 110 playing first UI video 41, device 110 may play second UI video 42 showing that second area 412 including a car changes in time.

As set forth above, a VOD header may include information regarding each address of respective UI videos and matching information that matches each of the UI videos with each user input. Thus, when remote controller receives a user input that pushes up navigation button 424 while first UI video 41 is played, device 110 may find out, by using matching information table 43, that the fifth UI video is matched with first UI video 41 and up navigation button 424. Further, device 110 may be configured to extract an address of the fifth UI video to search the fifth UI video by using the extracted address of the fifth UI video, and play the searched fifth UI video.

Although direction buttons such as right navigation button 422, up navigation button 424, left navigation button 426 and a down navigation button 428 are included in user input column 434, various buttons, such as 0 to 9 buttons, a sharp button, an asterisk button, etc., may be included in user input column 434.

Thus, FIG. 4B shows an illustrative example of matching information table 43 which may be included in a VOD header, in accordance with various embodiments described herein.

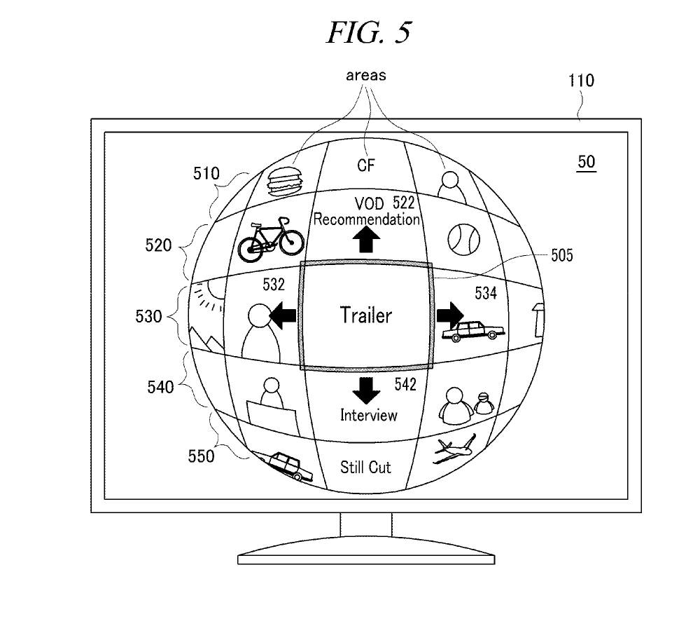

FIG. 5 shows an illustrative example of a 3D UI video 50 played by device 110 by which at least portions of playing of a UI video may be implemented, in accordance with various embodiments described herein.

As depicted in FIG. 5, device 110 may play spherical UI video 50 including lots of areas as the 3D UI video. Spherical UI video 50 may include a fixed select box 505, a first row 510 for commercial films (CFs) of the VOD content, a second row 520 for recommendation VODs, a third row 530 for trailer videos of the VOD content, a fourth row 540 for interview videos of actors, and a fifth row 550 for still cuts of the VOD content. Further, spherical UI 50 may include a row for advertisement corresponding to the VOD content, a row for homepage of the VOD content, a row for other VOD contents which the actors appear, etc.

Spherical UI displayed by playing of spherical UI video 50 may be rotated based at least in part on a user input. That is, every user input that one of navigation buttons (up, down, left, or right) on remote controller 120 is selected via remote controller 120, the spherical UI may be rotated by one area with a direction corresponding to the user input. By way of example, but not limitation, when remote controller 120 receives a user input that pushes a right navigation button, the spherical UI may be turned to the right by one area, so that an area 532 including a person may be positioned within fixed select box 505. Further, when the user pushes a up navigation button, the spherical UI may be turned upward by one area, so that an area 522 including a text “VOD Recommendation” may be positioned within fixed select box 505. Thus, the user may select left navigation or right navigation button to see another area in a same row, and up navigation or down navigation button to see another area in another row.

Similarly to FIG. 4A, not only all of the areas included in spherical UI video 50 but also only one area within fixed select box 505 may be changed in time.

Thus, FIG. 5 shows an illustrative example of 3D UI video played by device 110 by which at least portions of playing of a UI video may be implemented, in accordance with various embodiments described herein

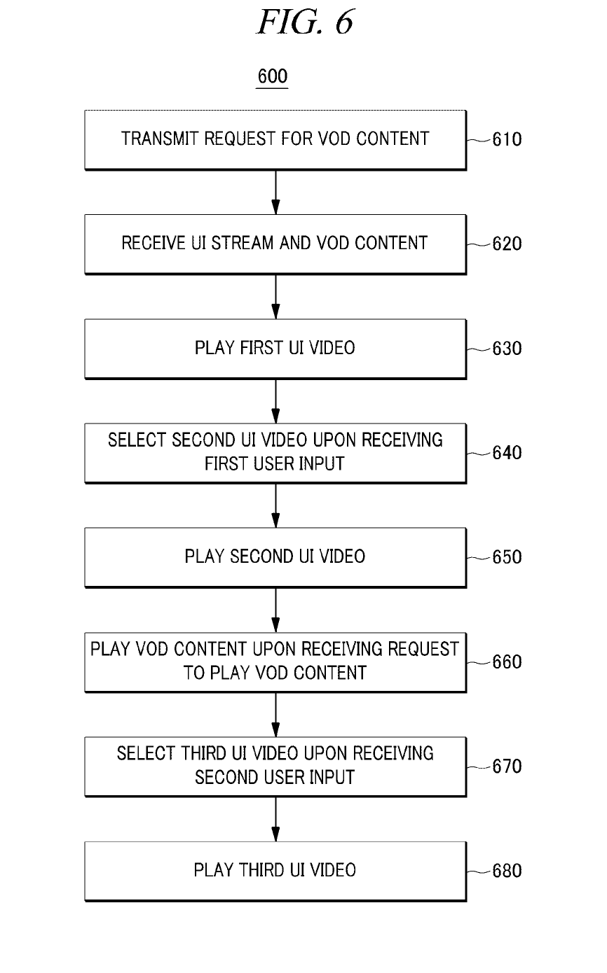

FIG. 6 shows an example processing flow of operations to implement at least portions of playing of a UI video may be implemented, in accordance with various embodiments described herein. The operations of processing flow 600 may be implemented in system configuration 100 including device 110, remote controller 120 and content provider 130, as illustrated in FIG. 1. Processing flow 600 may include one or more operations, actions, or functions as illustrated by one or more blocks 610, 620, 630, 640, 650, 660, 670 and/or 680. Although illustrated as discrete blocks, various blocks may be divided into additional blocks, combined into fewer blocks, or eliminated, depending on the desired implementation. Processing may begin at block 610.

Block 610 (Transmit Request for VOD Content) may refer to device 110 transmitting a request for VOD content to content provider 130. Processing may proceed from block 610 to block 620.

Block 620 (Receive UI stream and VOD Content) may refer to device 110 receiving a UI stream and the requested VOD content from content provider 130. As referenced herein, the UI stream may include a VOD header and a plurality of UI videos. Processing may proceed from block 620 to block 630. Further, the received plurality of UI videos are selected, by content provider 130, based at least in part on a viewing history of device 110.

In some embodiment, at least one of the plurality of UI videos may include an advertisement video selected, by content provide 130, based at least in part on metadata of the VOD content or a user profile of device 110.

Block 630 (Play First UI Video) may refer to device 110 playing a first UI video from among the plurality of UI videos. The first UI video may be automatically played upon receiving the plurality of UI videos. Alternatively, the first UI video may be played upon receiving a user input that requests for playing of the first UI video. Processing may proceed from block 630 to block 640.

Block 640 (Select Second UI Video Upon Receiving First User Input) may refer to device 110 receiving a first user input, and selecting a second UI video from among the plurality of UI videos based at least in part on the received first user input. Processing may proceed from block 640 to block 650.

Block 650 (Play Second UI Video) may refer to device 110 playing the selected second UI video. As referenced herein, the second UI video may be played with a full-screen size, instead of the first UI video. Processing may proceed from block 650 to block 660.

Block 660 (Play VOD Content Upon Receiving Request to Play VOD Content) may refer to device 110 receiving a user input that requests to play the VOD content. Further, device 110 may play the VOD content in response to the user input that requests to play the VOD content. Processing may proceed from block 660 to block 670.

Block 670 (Select third UI Video Upon Receiving Second User Input) may refer to device 110 receiving a second user input while the VOD content is played. Further device 110 may select a third UI video from among the plurality of UI videos based at least in part on the received second user input. Processing may proceed from block 670 to block 680.

Block 680 (Play Third UI Video) may refer to device 110 playing the selected third UI video.

Thus, FIG. 6 shows an example processing flow of operations to implement at least portions of playing of a UI video may be implemented, in accordance with various embodiments described herein.

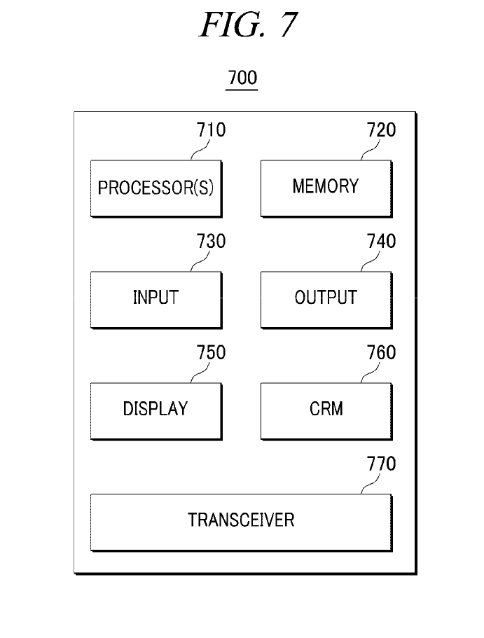

FIG. 7 shows an illustrative computing embodiment, in which any of the processes and sub-processes of a playing of a UI video may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the example system configuration 100 for transactional permissions.

In a very basic configuration, a computing device 700 may typically include, at least, one or more processors 710, a system memory 720, one or more input components 730, one or more output components 740, a display component 750, a computer-readable medium 760, and a transceiver 770.

Processor 710 may refer to, e.g., a microprocessor, a microcontroller, a digital signal processor, or any combination thereof.

Memory 720 may refer to, e.g., a volatile memory, non-volatile memory, or any combination thereof. Memory 720 may store, therein, an operating system, an application, and/or program data. That is, memory 720 may store executable instructions to implement any of the functions or operations described above and, therefore, memory 720 may be regarded as a computer-readable medium.

Input component 730 may refer to a built-in or communicatively coupled keyboard, touch screen, or telecommunication device. Alternatively, input component 730 may include a microphone that is configured, in cooperation with a voice-recognition program that may be stored in memory 730, to receive voice commands from a user of computing device 700. Further, input component 720, if not built-in to computing device 700, may be communicatively coupled thereto via short-range communication protocols including, but not limitation, radio frequency or Bluetooth.

Output component 740 may refer to a component or module, built-in or removable from computing device 700, that is configured to output commands and data to an external device.

Display component 750 may refer to, e.g., a solid state display that may have touch input capabilities. That is, display component 750 may include capabilities that may be shared with or replace those of input component 730.

Computer-readable medium 760 may refer to a separable machine readable medium that is configured to store one or more programs that embody any of the functions or operations described above. That is, computer-readable medium 760, which may be received into or otherwise connected to a drive component of computing device 700, may store executable instructions to implement any of the functions or operations described above. These instructions may be complimentary or otherwise independent of those stored by memory 720.

Transceiver 770 may refer to a network communication link for computing device 700, configured as a wired network or direct-wired connection. Alternatively, transceiver 770 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. In connection with a device having a user interface (UI), a method comprising:
transmitting a request for VOD (video on demand) content to a content provider;
receiving, from the content provider, a UI stream and the requested VOD content, the UI stream including a VOD header and a plurality of UI videos corresponding to the VOD content;
playing a first UI video from among the plurality of UI videos;
receiving a first user input;
selecting a second UI video from among the plurality of UI videos based at least in part on the first user input; and
playing the second UI video.

2. The method of claim 1, further comprising:
receiving a request to play the VOD content, and
wherein the receiving of the VOD content is performed after the receiving of the request to play the VOD content.

3. The method of claim 1, wherein the second UI video is played, with a full-screen size, instead of the first UI video.

4. The method of claim 1, further comprising:
receiving a UI data corresponding to the VOD content from the content provider; and
displaying the received UI data.

5. The method of claim 4, wherein the first UI video or the second UI video is played on a predetermined area on the displayed UI data.

6. The method of claim 1, wherein at least one of the plurality of UI videos includes an advertisement video selected, by the content provider, based at least in part on metadata of the VOD content or a user profile of the device.

7. The method of claim 1, wherein the VOD header includes information regarding each address of the plurality of UI videos and matching information that matches each of the plurality of UI videos with each user input.

8. The method of claim 1, further comprising:
playing the VOD content;
receiving a second user input;
selecting a third UI video from among the plurality of UI videos based at least in part on the second user input; and
playing the third UI video.

9. The method of claim 1, wherein the receiving of the plurality of UI videos is performed prior to the receiving of the VOD content.

10. The method of claim 1, wherein the first UI video is played repeatedly if the first user input is not received although the playing of the first UI video is completed.

11. The method of claim 1, wherein both of the first UI video and the second UI video are simultaneously played.

12. The method of claim 1, wherein the received plurality of UI videos are selected, by the content provider, based at least in part on a viewing history of the device.

13. A device, comprising:
a transmitter configured to transmit a request for VOD (video on demand) content to a content provider;
a receiver configured to receive, from the content provider, a UI stream and the requested VOD content, the UI stream including a VOD header and a plurality of UI videos corresponding to the VOD content;
a user input receiver configured to receive a user input;
a controller configured to select a UI video from among the plurality of UI videos based at least in part on the user input; and
a reproducing unit configured to play the selected UI video in response to an instruction of the controller.

14. The device of claim 13, wherein the user input receiver is further configured to receive a request to play the VOD content, and
wherein the receiving of the VOD content is performed after the receiving of the request to play the VOD content.

15. The device of claim 13, wherein the receiver is further configured to receive a UI data corresponding to the VOD content from the content provider, and
wherein the reproducing unit is further configured to display the UI data.

16. The device of claim 15, wherein the UI video is played on a predetermined area on the displayed UI data.

17. The device of claim 13, wherein the receiving of the plurality of UI videos is performed prior to the receiving of the VOD content.

18. A system, comprising:
a content provider configured to:
receive a request for VOD (video on demand) content; and
transmit a UI stream and the requested VOD content, the UI stream including a VOD header and a plurality of UI videos corresponding to the VOD content, and
a device configured to:
receive the UI stream and the VOD content from the content provider;
play a first UI video from among the plurality of UI videos;
receive a user input;
select a second UI video from among the plurality of UI videos based at least in part on the user input; and
play the second UI video.

19. The system of claim 18, wherein the device is further configured to:
receive a UI data from the content provider,
display the UI data, and
wherein the first UI video or the second UI video is played on a predetermined area on the displayed UI data.

20. The system of claim 18, wherein both of the first UI video and the second UI video are simultaneously played.
